(19) United States
(12) Patent Application Publication
(10) Pub. No.: US 2008/0271108 A1
(43) Pub. Date: Oct. 30, 2008

(54) Satellite and cable ready TV display device

(76) Inventors: Wanwen Shi, Shenzhen (CN); Huajun Wang, Mississauga (CA); Shangguo Ning, Shenzhen (CN); Tongjun Wang, Shenzhen (CN)

Correspondence Address: MORGAN LEWIS & BOCKIUS LLP, 1111 PENNSYLVANIA AVENUE NW, WASHINGTON, DC, 20004, US

(21) Appl. No.: 12/081,553

(22) Filed: Apr. 17, 2008

(30) Foreign Application Priority Data
Apr. 24, 2007 (CN) 200710074155.X
Apr. 27, 2007 (CN) 200710074237.4

(51) Int. Cl. H04N 7/173

(52) U.S. Cl. 725/152

(57) ABSTRACT

A display system includes a display device including a plurality of signal decoders, a video processing module, and an audio processing module, the display device excludes a tuner device, and a signal receiving module including a tuner module and a demodulator module, wherein the signal receiving module is removably connected to the display device.

The present invention claims the benefit of the Chinese Patent Application Nos. 200710074155.X and 200710074237.4, filed on Apr. 24, 2007 and Apr. 27, 2007, respectively, in China, which are hereby incorporated by reference.

### BACKGROUND OF THE INVENTION

1. Field of the Invention

The present invention relates to a television display device, and more particularly, to a television display device capable of processing television signals.

2. Description of the Related Art

Currently, there exist two fundamental types of television signal broadcasts. A first fundamental type includes “over the air” signal broadcasting that requires an external antenna to receive the broadcasted signals. This first fundamental type is considered to be analog-based broadcast signals, whereby the quality of the images produced on an analog display device is considered relatively poor. Moreover, the analog-based broadcast signals will soon be replaced exclusively with digital broadcast signals, thereby rendering analog display devices exclusively configured for receiving the analog-based broadcast signals obsolete unless they are implemented with additional converter devices.

The second fundamental type of television broadcast includes digital-based broadcast signals that produce very high quality images on a display device. The display devices used to produce display images from the digital-based broadcast signals include two basic configurations. FIG. 1 shows a display system configuration that includes a display device 4 connected to a converter box 3, wherein the converter box 3 converts the digital broadcast signals using a tuner 31 and a demodulator 32 that receives amplified intermediate frequency (IF) signals from the tuner 31. In addition, the converter box 3 includes signal processing devices, such as a transport stream (TS) demultiplexer 33, and MPEG-2 decoder 34, and video and audio outputs 36 and 37. The converter box 3 also includes a micro chip unit (MCU) 38 to receive remote control signals from a remote controller 30 through a remote controlling pre-processing module 39 to control the tuner 31, as well as an electrically erasable programmable read-only memory (EEPROM) 301, using an Inter-Integrated Circuit (I2C) bus. However, due to the differences in transmission standards of the digital-based broadcast signals, different tuners and demodulators are required.

In FIG. 1, the broadcast display device 4 converts the broadcast signals and displays images, and includes a video and audio processing module 43, as well as a video and audio output module 44, an EEPROM 40, an MCU 41, and a remote controlling sending and receiving pre-processing module 42. Here, the MCU 41 receives remote controlling signals from the remote controller 5 to control the video and audio processing module 43, the video and audio output module 44 and the EEPROM 40 through the I2C bus.

FIG. 2 shows an integrated display system including a display device 1 having signal processing devices including a tuner 11, a demodulator 12 receiving amplified IF signal from the tuner 11, a TS demultiplexer 13, an MPEG-2 decoder 15, a video and audio processor 16, as well as a video and audio output module 17, and external output modules including an external video output 18, and an external audio output 19. The integrated digital device 1 also includes a MCU 20 receiving remote controlling signals from a remote controller 2 to control the signal processing device, as well as an EEPROM 21 through the I2C bus. However, due to differences in transmission standards of integrated digital display devices, different tuners are required.

Functions of the integrated digital display devices include signal tuning and image displaying. However, since most modern display devices implement the second fundamental type of television broadcasts, i.e., digital-based broadcast signals, integration of a tuner within the display device is not necessary. Accordingly, a need exists that allows users to choose according to whether or not a separate tuner is required. Specifically, when a user does not need a tuner, they can chose a display device without a tuner, or when a user needs a tuner, they can purchase a separate tuner to match the configured use of a digital TV without a tuner.

### SUMMARY OF THE INVENTION

Accordingly, the present invention is directed to a display device that substantially obviates one or more of problems due to limitations and disadvantages of the related art.

An object of the present invention is to provide a display device capable of producing video images from multiple signal sources.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a display system includes a display device including a plurality of signal decoders, a video processing module, and an audio processing module, the display device excludes a tuner device, and a signal receiving module including a tuner module and a demodulator module, wherein the signal receiving module is removably connected to the display device.

In another aspect, a display system includes a display device, the display device excludes a tuner device internal to the display device, and a signal receiving module including a tuner module and a demodulator module removably connected to the display device, wherein the display device sets parameters for the signal receiving module.

In another aspect, a method for controlling a display system includes providing a signal receiving module to a display device having a first case enclosing signal decoders, video processing modules, and audio processing modules, the display device excludes a tuner, wherein the signal receiving module has a second case removably connected to the first case of the display device, the signal receiving module receiving signals transmitted by one of a satellite and an electrical cable.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic of a display system configuration according to the related art;

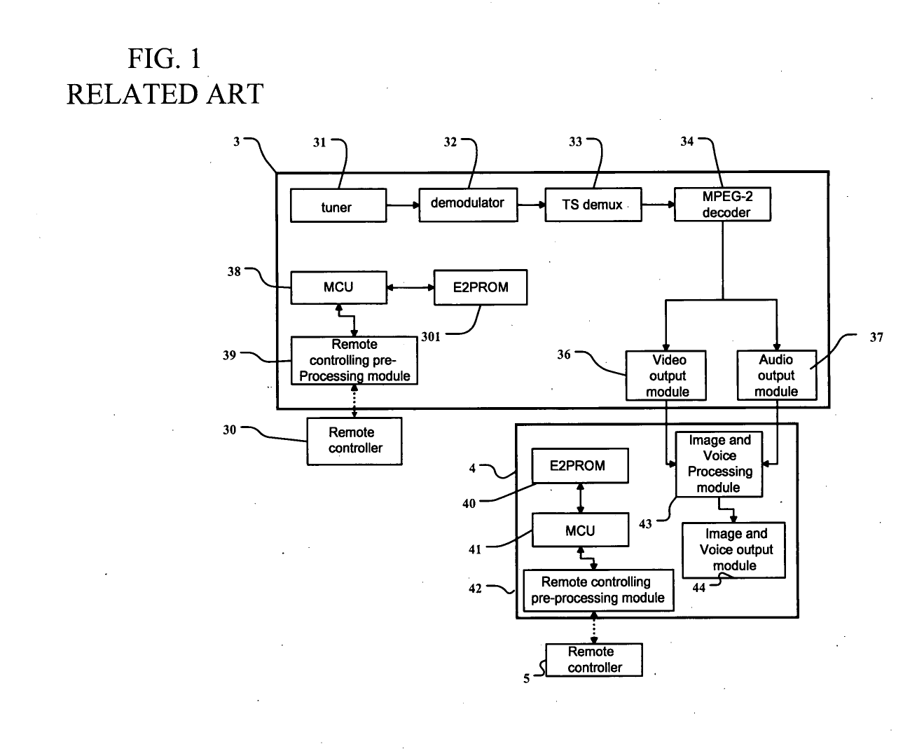

FIG. 2 is a schematic of an integrated display system according to the related art;

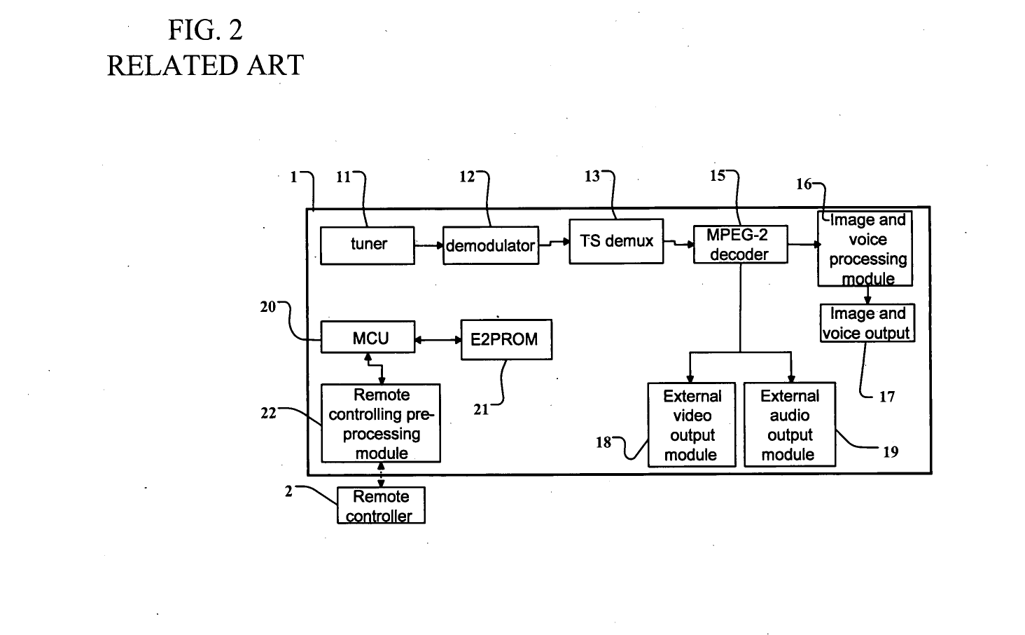

FIG. 3 is schematic of an exemplary display device according to the present invention;

FIG. 4 is a schematic of an exemplary module device according to the present invention;

FIG. 5 is a diagram of an exemplary connection configuration module and broadcast devices according to the present invention; and

FIG. 6 is a schematic of an exemplary display device according to the present invention.

### DETAILED DESCRIPTION OF THE PREFERRED EMBODIMENTS

Reference will now be made in detail to the illustrated embodiments of the present invention, which are illustrated in the accompanying drawings.

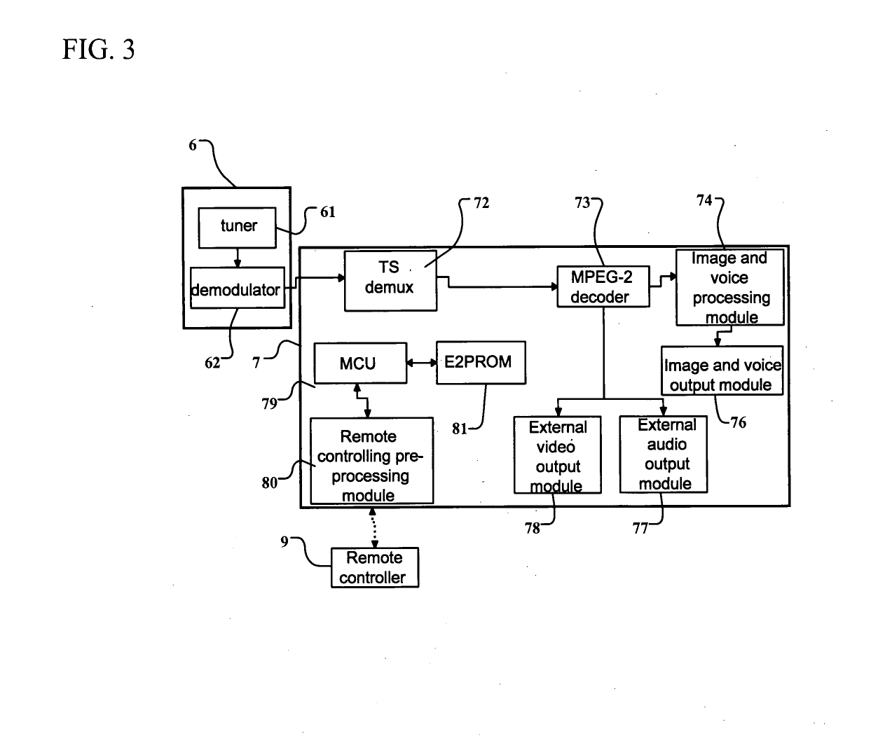

FIG. 3 is schematic of an exemplary display system according to the present invention. In FIG. 3, a broadcast display device 7 has signal processing devices including a TS demultiplexer 72, an MPEG-2 decoder 73, a video and audio processor module 74, as well as a video and audio output module 76. In addition, the broadcast display device 7 has external output modules including an external video output module 78, and an external audio output module 77. The broadcast display device 7 includes a remote controlling processing module 80, and an MCU 79 receiving remote control signals sent from an external remote controller 9. The MCU 79 controls the signal processing devices through an I2C bus, as well as an EEPROM 81.

In FIG. 3, a signal receiving device 6 includes a tuner 61 and a demodulator 62, wherein the tuner 61 may receive broadcast signals transmitted by terrestrial broadcasting systems or broadcast signals transmitted by satellite broadcasting systems. The signal receiving device 6 may be used for the frequency conversion and filtering of the broadcast signals and the demodulation of the broadcast signals received by the tuner 61.

According to the present invention, the signal receiving device 6, including the tuner 61 and demodulator 62, may constitute an independent broadcast signal receiving device. Accordingly, the broadcast display device 7 may be configured and manufactured without a signal receiving device 6. For users having broadcast signals received via a cabled signal source, i.e., cable TV, it is not necessary to purchase an independent television signal receiving device 6. For users having broadcast signals received via a wireless signal source, i.e., satellite TV, a television signal receiving device 6 may be required to receive the wireless broadcast signals. Accordingly, the user receiving the broadcast signals via the wireless signal source, may purchase an independent television signal receiving device 6 to support the use of the broadcast display device 7.

According to the present invention, a key to separating a broadcast signal receiving device from a display system is how to use an independent broadcast signal receiving device to support use of a broadcast display device without signal tuning and demodulating part when users that need to use a broadcast signal receiving device to receive wireless broadcast signals who purchase the independent broadcast signal receiving device. One aspect to solve this problem, according to an exemplary embodiment of the present invention, includes installation of a removable plug-in type module device in the independent broadcast signal receiving device for interconnecting with the broadcast display device.

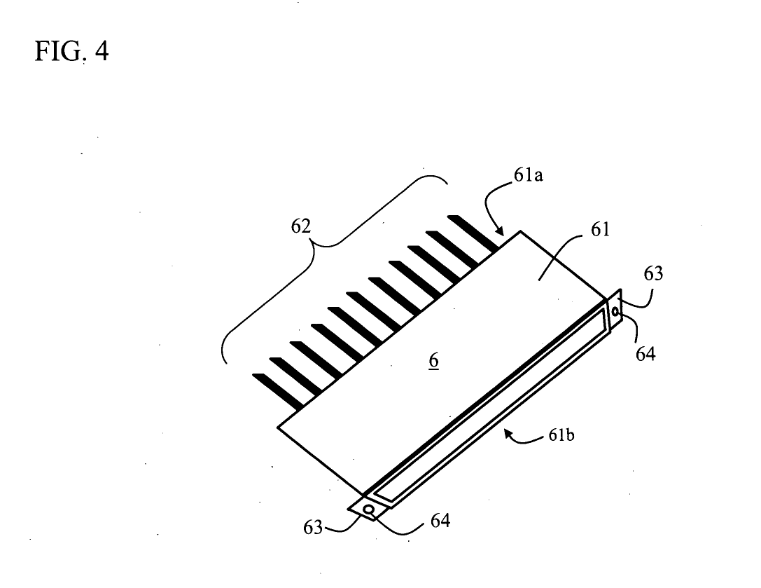

FIG. 4 is a schematic of an exemplary module device according to the present invention. In FIG. 4, a module device 6 includes a main body portion 61 containing necessary signal processing devices including at least tuner(s), demodulator(s), multiplexer(s), and memory devices, for example. The module device 6 provides for receiving of broadcast signals, and may be considered a receiver module of the broadcast signals. The module device 6 further includes a plurality of electrodes 62 protruding from the main body portion 61. Although the electrodes 62 protrude from the main body portion 61 other types of electrode structure may be easily substituted that may not protrude from the main body portion 61. Moreover, although the electrodes 62 protrude along a rear surface 61 a of the main body portion 61, the electrodes 62 may be provided on another surface of the main body portion 61, as well as along other multiple surfaces of the main body portion 61. In addition, the module device 6 may include fastening tab members 63 having fastening holes 64 extending therethrough.

In FIG. 4, the main body portion 61 of the module device 6 may include a front surface 61b that may be formed as a unitary sealed surface or may be formed having an input port (not shown) in order to provide access to the signal process devices disposed within the main body portion 61. The access may include electrical access to the signal processing devices and/or physical access to the signal processing devices. For example, the signal processing devices within the main body portion 61 may be accessed electrically to provide electrical communications from an exterior of the module device 6 using standard plug/socket or wireless devices.

In FIG. 4, when the module device 6 is connected to a broadcast display device 7 (in FIG. 3) through plug/socket devices, the broadcast device may provide power supply for the module device 6. In addition, the module device 6 and the broadcast display device 7 may communicate with each other by a communications port integrated with the plug/socket devices. This power supply interface and communication port may be integrated together to facilitate installation. Accordingly, the module device 6 transmits the processed broadcast signals through the communication port to the broadcast display device 7, and the broadcast display device 7 may perform further signal processing.

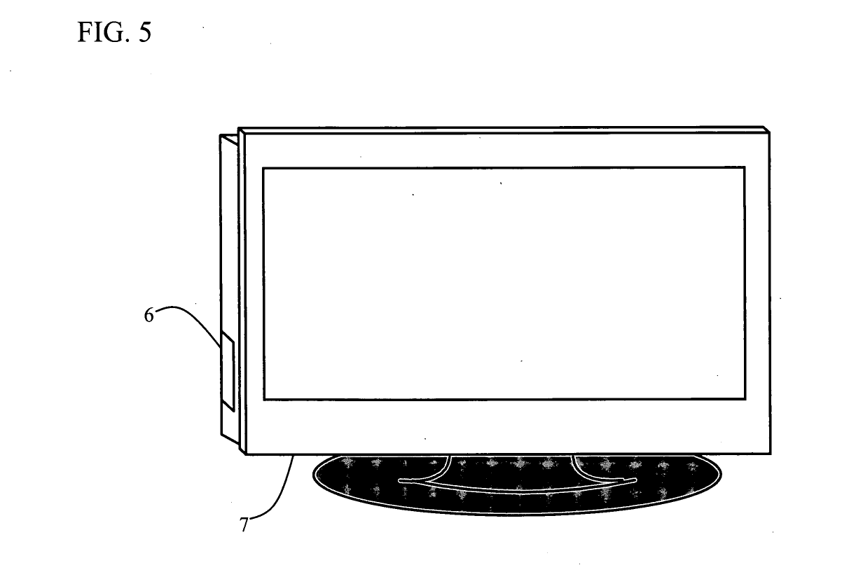

FIG. 5 is a diagram of an exemplary connection configuration module and broadcast devices according to the present invention. In FIG. 5, the module device 6 may be inserted into a side portion of the broadcast display device 7 to be flush with the exterior surface of the broadcast display device 7. Alternatively, the module device 6 may be wholly inserted within a cavity of the broadcast display device 7 such that a door or hatch of the broadcast display device 7 may cover the module device 6. Moreover, the module device 6 may be provided at other locations with regard to the broadcast display device 8. For example, the module device 6 may be provided at a top, bottom, or rear region of the broadcast display device 7.

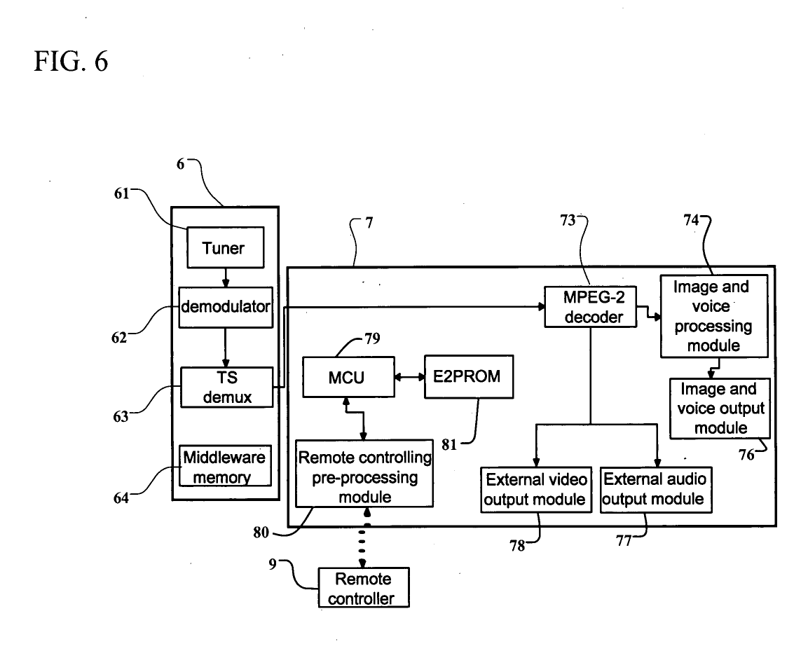

FIG. 6 is a schematic of an exemplary display device according to the present invention. In FIG. 6, communication between a module device 6 and a broadcast display device 7 may be controlled by the broadcast display device 7, where the broadcast display device 7 may transmit instructions based on a corresponding communications protocol to the module device 6. Accordingly, module device 6 may function under the instructions received from the broadcast display device 7. The communications protocol may include a protocol, such as I2C or Universal Serial Bus (USB). However, since the I2C protocol is presently supported by a common majority of electronic chip sets, the I2C protocol may be preferred. Of course, as additional protocols are created and adopted by industry, the present invention may implement these additional protocols.

As detailed above, for different broadcast signal sources, the tuner and demodulator combinations may be quite different. Since the tuner is installed in the broadcast display device prior to shipping of the broadcast display device to retail sales locations, as in the related art, broadcast display device manufacturers must set parameters of the tuner in the broadcast display device according to the model and parameters of the tuner. However, according to the present invention, the broadcast display device may be manufactured may only include the broadcast display device without a tuner and demodulator, wherein the signal receiving device may be individually configured and purchased separately by the user. Thus, manufacture of the broadcast display devices may be standardized, thereby reducing costs, and the signal receiving devices may be purchased and installed by the user for specific type of broadcast signal sources.

In order to correctly control the signal receiving device, which includes necessary signal processing devices such as tuners, demodulators, memories, etc., some information may be pre-stored in the broadcast display device prior to arrival at retail sales locations. Accordingly, basic parameters of the signal receiving device may be included with the broadcast display device such as:
SET POINT1: value of the frequency boundary of very low (VL) and very high (VH) set by factory;
SET POINT2: value of the frequency boundary of VH and UH set by factory;
DATA VL: value of the very low frequency (VLF) in the Band switching Register set by factory;
DATA VH: value of the very high frequency (VHF) in the Band switching Register set by factory;
DATA UH: value of the ultra high frequency (UHF) in the Band switching Register set by factory; and
CP: value of the BIT6 CP in the Tuning step data register set by factory.

Since different tuners are for different broadcast display device models, the parameters detailed above are usually different. Accordingly, the broadcast display device controls the signal receiving device to function according to parameters detailed above. When the signal receiving device and broadcast display device are interconnected, the broadcast display device provides the user with an interface to set the parameters detailed above. Thus, the user can set the six parameters through the interface according to the model and parameters of the tuner. Similarly, when the signal receiving device and the broadcast display device interconnected, the broadcast display device may provide the user with an interface to set the parameters of the demodulator in the signal receiving device, so that the broadcast display device may control the signal receiving device.

After setting the parameters of the tuner and demodulator using the interface(s), the signal receiving device may transmit communications to the broadcast display device under control of the broadcast display device. However, since the parameter setting process is a relatively complicated procedure for normal users to follow, a simpler way may be provided.

According to the present invention, a software program may be implemented, such as middleware, which makes the software programming substantially independent from the device hardware. To achieve the parameter settings of the tuner and the demodulator in the signal receiving device, a simpler way is to instruct users to load a middleware program designed according to the specific signal receiving device to comply with the software interface of the broadcast display device from the signal receiving device to the broadcast display device. When the broadcast display device is connected with the signal receiving device, the broadcast display device may execute the middleware to control the tuner and the demodulator in the signal receiving device.

The middleware provides some exemplary functional interfaces that are relatively simple. The middleware may include exemplary steps of:
1. the broadcast display device sets the standards of the current broadcast signal in the middleware through the interfaces. The middleware initialize the signal receiving device according to the standards of the current broadcast signal;
2. the broadcast display device sets the frequency of the current channel in the middleware through the interfaces. The middleware initialize the tuner according to the frequency of the current channel.
3. the broadcast display device reads some information of the current broadcast signal through the interfaces, such as the intensity of the signal, the mode of the signal, etc, and sets the signal receiving device according to the information; and
4. the broadcast display device reads some information of a working state(s) of the signal receiving device through the interfaces and sets the signal receiving device according to the information.

These exemplary interfaces may be considered basic interfaces, and may further include additional interfaces or different interfaces. The designs of these exemplary interfaces are based mainly on the standards of the interfaces of the broadcast display device. If the manufacturers of the signal receiving device design the middleware based on the standard of the interfaces of the broadcast display device, a user interconnects the signal receiving device and the broadcast display device, and loads the middleware into the broadcast display device, then the broadcast display device directs the signal receiving device to function/communicate.

The process to load the middleware into the broadcast display device may be relatively difficult for some users. Accordingly, a simpler way includes the broadcast display device automatically reading the middleware stored in a memory in the signal receiving device when the signal receiving device is connected to the broadcast display device.

In FIG. 6, an exemplary memory to store the middleware in the signal receiving device 6 is representatively-shown as the memory 64. When the signal receiving device 6 is connected to the broadcast display device 7, the broadcast display device 7 reads the middleware from the memory 64 and automatically installs the middleware into the signal receiving device 6 and/or the broadcast display device 7, or according to a user's instructions. In FIG. 6, the signal receiving device 6 includes the tuner 61 and the demodulator 62, and can also include the TS demultiplexer 63. The demodulator 62 may transmit the transport stream to the TS demultiplexer 63, in order to demultiplex the transport stream.

For a simple plug-and-play version of the signal receiving device 6, drivers and corresponding detection procedures may be installed in the broadcast display device 7 in advance. When the signal receiving device 6 and the broadcast display device 7 are interconnected, the broadcast display device 7 may activate the drivers and the corresponding detection procedures.

The drivers to drive the signal receiving device 6 are mainly the procedures to drive the tuner, including the drivers to drive a voltage-synthetic tuner and a frequency-synthetic tuner. When the broadcast display device 7 is powered ON, the broadcast display device 7 may first initiate the drivers to drive the voltage-synthetic tuner/frequency-synthetic tuner, and then may run the corresponding detection procedures to detect a synchronous signal. If a synchronous signal is detected, the broadcast display device 7 judges that the tuner is in a working state. Otherwise the broadcast display device 7 may initiate the drivers to drive the voltage-synthetic tuner/frequency-synthetic tuner and may run the corresponding detection procedures to detect a synchronous signal.

The transmission and processing of the broadcast signal is accompanied with the synchronous signal whether the broadcast signal is an analog-based broadcast signal or a digital-based broadcast signal. If the broadcast signal is not accompanied with the synchronous signal, an image may not be displayed correctly on the display device. Accordingly, the detection of a synchronous signal may be interpreted as the broadcast signal having been accompanied with the broadcast signal. It is convenient to detect the synchronous signal since the frequency and magnitude of the synchronous signal are both fixed. The process of detecting the synchronous signal may include a process of pulse signal detection, or may include other detection processes.

To separate the signal receiving device 6 from the broadcast display device 7 is an effective way to reduce the cost of the broadcast device, and thus, the display device. Users may purchase a signal receiving device 6 to support the function(s) of the broadcast display device 7, if necessary. If it is not necessary to support the broadcast display device 7, then users can use the broadcast display device 7 separately to watch broadcast programs, avoiding unnecessary expenses.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A display system, comprising:
a display device including a plurality of signal decoders, a video processing module, and an audio processing module, the display device excludes a tuner device; and
a signal receiving module including a tuner module and a demodulator module,
wherein the signal receiving module is removably connected to the display device.

2. The system according to claim 1, wherein the signal receiving module further includes a transport stream demultiplexer module that electrically communicates with at least one of the plurality of signal decoders of the display device.

3. The system according to claim 1, wherein the signal receiving module receives digital signals transmitted by one of a satellite and an electrical cable.

4. The system according to claim 1, wherein the signal receiving module further includes a memory module having middleware.

5. The system according to claim 4, wherein the middleware provides a plurality of user interfaces to perform at least one of initializing the signal receiving module according to standards of a signal, initializing the tuner module according to a frequency of a current channel, reading information of a current signal, and reading information of a working state of the signal receiving module and setting the signal receiving module according to the information.

6. The system according to claim 5, wherein the reading of information of a current signal includes information regarding at least one of an intensity of the signal and a mode of the signal.

7. The system according to claim 1, wherein the signal receiving module is disposed within a cavity of the display device.

8. The system according to claim 1, wherein the display device controls communications with the signal receiving module.

9. The system according to claim 8, wherein the signal receiving module functions according to instructions provided by the display device.

10. The system according to claim 9, wherein the instructions are a part of a digital communications protocol.

11. A display system, comprising:
a display device, the display device excludes a tuner device internal to the display device; and
a signal receiving module including a tuner module and a demodulator module removably connected to the display device,
wherein the display device sets parameters for the signal receiving module.

12. The system according to claim 11, wherein the display device drives the tuner of the signal receiving module.

13. The system according to claim 12, wherein the tuner is one of a voltage-synthetic tuner and a frequency-synthetic tuner.

14. The system according to claim 11, wherein the display device initiates a detection procedure with the signal receiving module to detect a synchronous signal.

15. A method for controlling a display system, comprising:
providing a signal receiving module to a display device having a first case enclosing signal decoders, video processing modules, and audio processing modules, the display device excludes a tuner,
wherein the signal receiving module has a second case removably connected to the first case of the display device, the signal receiving module receiving signals transmitted by one of a satellite and an electrical cable.

16. The method according to claim 15, wherein the signal receiving module further includes one of a transport stream demultiplexer module and a memory module having middleware.

17. The method according to claim 16, further comprising providing a plurality of user interfaces by the middleware to perform at least one of initializing the signal receiving module according to standards of a signal, initializing the tuner module according to a frequency of a current channel, reading information of a current signal, and reading information of a working state of the signal receiving module and setting the signal receiving module according to the information.

18. The method according to claim 17, wherein the reading of information of a current signal includes information regarding at least one of an intensity of the signal and a mode of the signal.

19. The method according to claim 15, wherein the signal receiving module functions according to instructions provided by the display device, the instructions include a digital communications protocol.

20. The method according to claim 15, further comprising setting parameters for the signal receiving module by the display device, driving the tuner of the signal receiving module by the display device, and initiating a detection procedure with the signal receiving module to detect a synchronous signal by the display device.
